(19) United States
(12) Patent Application Publication
(10) Pub. No.: US 2016/0083993 A1
(43) Pub. Date: Mar. 24, 2016

(54) HINGE AND METHOD OF ASSEMBLING SAME

(71) Applicant: Kason Industries, Inc., Newnan, GA (US)

(72) Inventors: Brian Grewe, Conyers, GA (US); Brett A. Mitchell, Newnan, GA (US); Burl M. Finkelstein, Newnan, GA (US)

(73) Assignee: Kason Industries, Inc.

(21) Appl. No.: 14/492,947

(22) Filed: Sep. 22, 2014

(51) Int. Cl. E05F 1/10

(52) U.S. Cl. CPC E05F 1/1008

(57) ABSTRACT

There is disclosed a hinge (10) having a cartridge (12) with a round interior channel (16), a mounting flange (20) with a mounting hole (24) therein, a bushing (28), a pivot pin (33) having a square shoulder section (43) and a round shaft (44), a cam follower (49), a cam (50), a compression spring (51) and a spring retainer (52). The cam follower has a square mounting hole (55) which fits within the square shoulder section. The cam includes central hole (58) configured to receive the pivot pin shaft. The cam includes elongated guides (61). A cabinet mounting bracket (72) is coupled to the pivot pin. The hinge is assembled by coupling the cam follower onto the pivot pin prior to placing the combination into the cartridge with the pivot pin square shoulder section received within the cam follower square mounting hole to prevent relative rotation therebetween.

### TECHNICAL FIELD

This invention relates generally to door hinges, and more particularly to hinges used for commercial refrigerator and freezer doors, and a method of assembling a hinge.

### BACKGROUND OF INVENTION

Heavy doors, such as those used on walk-in refrigerators, are often mounted to jambs by hinges which compress a spring as the door is swung open, and which use the force of the compressed spring against a cam assembly to assist in the closing of the door. These hinges may have two barrels mounted one above the other. Each barrel has a mounting flange laterally extending therefrom. The flange of one barrel is secured to the door and the flange of the other barrel is secured to the jamb. Another type of hinge is in the form of a cartridge which fits within a channel within the door itself and has two brackets wherein one bracket is mounted to the door and the other bracket is mounted to the door jamb or cabinet to enable pivoting of the door.

In the past, these cartridge type hinges have been designed to include a cylindrical cam which is telescopically mounted within the round channel of the cartridge or housing. Because of tolerances between these two components, the cam may bind within the barrel, thereby causing a malfunction of the hinge.

Also, in the past, the cam follower has been made unitarily with the pivot pin so that it is formed as one unit. Because of this uniformed construction, the pivot pin and cam follower combination is made out of a moldable or castable metal such as zinc. The problem is that a zinc pivot pin does not provide superior strength characteristics and therefore it may shear during use. Also, the cam co-operating with the cam follower is typically made of a plastic material, which can wear prematurely when riding upon the zinc metal cam follower. To overcome this problem, some cartridge type hinges have been constructed by molding or “overmolding” the plastic cam follower onto a steel pivot pin. While this provides for a steel pivot pin and a plastic cam follower, this method of construction is time consuming and expensive. Furthermore, as the pivot pin and cam follower becomes one unit through the overmolding process, the cam follower cannot later be removed from the pivot pin for repair or replacement purposes.

It thus is seen that a need remains for a camming assisted hinge which alleviates the problem associated with the binding of the cam within the barrel and the coupling of the cam follower to the pivot pin associated with those of the prior art. It is to the provision of such therefore that the present invention is primarily directed.

### SUMMARY OF THE INVENTION

In a preferred form of the invention a method of assembling a hinge comprising the steps of (A) providing a tubular hinge housing having an interior channel terminating at an end wall with a pivot pin mounting hole therethrough, a mounting flange extending outwardly from the tubular hinge housing, a bushing configured to lit within the tubular hinge housing end wall pivot pin mounting hole, a casement mounting bracket, a metal pivot pin having at least cam follower mounting portion with a non-round shoulder section and a round shaft section, a separate and distinct cam follower having a non-round hole therein configured to mate with the pivot pin cam follower mounting portion non-round shoulder section, a cam corresponding to the cam follower and having a channel therein configured to receive the pivot pin round shaft section, a compression spring, and a spring retainer; (B) positioning the distinct and separate cam follower onto the metal pivot pin with the cam follower non-round hole receiving the pivot pin non-round shoulder section; (C) inserting the bushing and the combination metal pivot pin and cam follower into the interior channel of the tubular hinge housing with a portion of the pivot pin extending from the tubular hinge housing end wall pivot pin mounting hole; (D) positioning the cam onto the cam follower with the metal pivot pin extending through the cam channel; (E) positioning the spring against the cam; (F) positioning the spring retainer against the spring opposite the cam; (G) coupling the spring retainer to the tubular hinge housing, and (H) coupling the casement mounting bracket to the portion of the pivot pin extending from the tubular hinge housing end wall pivot pin mounting hole.

### BRIEF DESCRIPTION OF THE DRAWINGS

FIG. 1 is a perspective view of a hinge embodying principles of the invention in a preferred form.

FIG. 2 is an exploded, perspective view of the hinge of FIG. 1.

FIG. 3 is a cross-sectional view of the hinge of FIG. 1.

FIG. 4 is across-sectional view of the hinge of FIG. 1, shown in an elevated condition.

FIG. 5 is a top view of the cam of the hinge of FIG. 1.

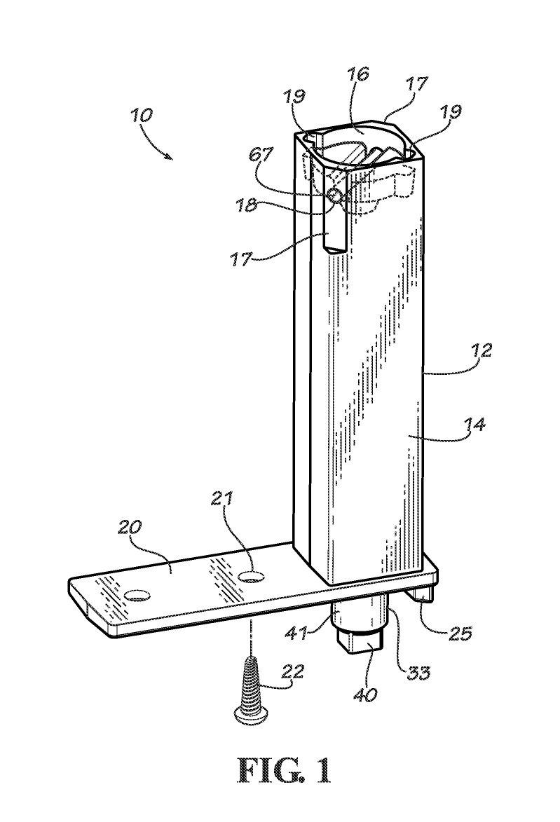

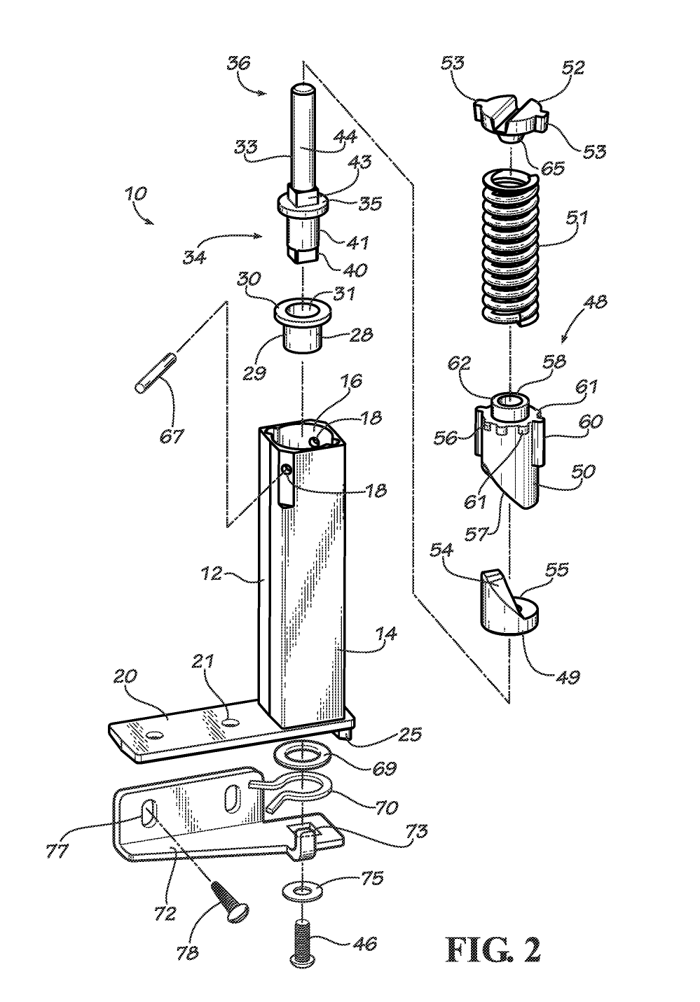

### DETAILED DESCRIPTION

With reference next to the drawings, there is shown a hinge 10 according to the present invention, shown in a conventional cartridge hinge form. It is to be appreciated that the hinge 10 shown in the drawings is configured for use with a conventional refrigerator or freezer door, but may also be utilized with other types of doors. The jamb and doors are well-known in the art and need not be disclosed further herein. It is to be further appreciated that the hinge 10, either alone or in combination with another hinge or pivot mechanism, support a door (not shown) in the usual manner.

The hinge 10 includes a tubular metal housing or cartridge 12 with a generally square external shape or surface 14 and a generally round interior channel 16. The cartridge 12 is configured to fit within a generally square shaped door channel extending into one end of an unshown door. The cartridge external surface 14 includes two oppositely disposed bevels 17 located at oppositely disposed corners. Each bevel 17 has a roll pin mounting hole 18 therethrough which are mutually aligned. The cartridge round interior channel 16 has two outwardly extending, oppositely disposed slots, keyways or grooves 19.

A generally flat door mounting flange 20 is fixedly coupled to one end of the metal cartridge 12 which also forms an end wall. The door mounting flange 20 includes two mounting holes 21 therethrough through which mounting screws 22 are passed and threaded into unshown door. The door mounting flange 20 also includes a round pivot pin mounting hole 24 which is centrally aligned with the cartridge interior channel 16 and an end stop flange 25 extending perpendicularly to the majority or longitudinal length of the mounting flange 20.

A bushing 28 is mounted within the pivot pin mounting hole 24. The bushing 28 has a cylindrical main portion 29, an annular, outwardly extending flange 30, and a central passage 31. The main portion 29 fits within the pivot pin mounting hole 24 while the flange 30 abuts or rests against the door mounting flange 20. The bushing 28 may be made of any conventional material, such as a self-lubricating nylon or the like.

A metal hinge rod or pivot pin 33 is centrally mounted within the cartridge interior channel 16. The pivot pin 33 includes a mounting portion 34, an outwardly extending annular stop or bearing flange 35, and a camming system mounting portion 36, all of unitary construction and preferably made of steel. The mounting portion 34 has a square shaped end section 40 extending to a cylindrical section 41 configured to be received within the bushing central passage 31 with the square shaped end section 40 extending from the bushing 28 so as to be exposed outside the confines of the cartridge. The end of the square shaped end section 40 includes a threaded hole 45 configured to threadably receive a threaded bracket mounting screw 46. The camming system mounting portion 36 includes a square shoulder section 43 and a round or cylindrical shaft section or shaft 44.

The hinge 10 also includes a camming system 48 which includes a cam follower 49, a corresponding cam 50, a helical cam compression spring 51 and a spring retainer 52. The cam 50 and cam follower 49 enables the hinge to be a cam assembly assisted or self-closing hinge. The cam 50 and cam follower 49 are preferably made of a smooth, low-frictional plastic material such as nylon, the term plastic herein being used to describe all plastics, polymers, or other similar type materials.

The cam follower 49 is generally cylindrical with a dual sloped camming surface 54. The cam follower 49 also includes a square mounting hole 55 which is configured to snugly fit about or receive the pivot rod square shoulder section 43 to prevent relative rotation between the cam follower 49 and the pivot pin 33.

The cam 50 has a generally cylindrical external surface 56 and a dual sloped camming surface 57 which corresponds with or mates with the cam follower camming surfaces 54. The cam 50 includes a round central hole or channel 58 configured to receive the pivot pin shaft section 44 for rotational and longitudinal relative movement between the cam and pivot pin. The cam 50 includes two oppositely disposed ridges, projections, flanges, keys, or tongues 60 which are configured to be received within the cartridge grooves 19 so as to prevent relative rotation between the cam 50 and the cartridge 12. The cam 50 also includes a radial array of elongated ridges or guides 61 extending outwardly from the periphery of the cylindrical external surface 56. The cam periphery or external diameter or circumference is defined by the outboard or outermost extent of the radial array of guides 61 and is configured to fit closely within or correspond to the interior dimensions or diameter of the cartridge interior channel 16. The cam 50 also includes a flange or collar 62 which is configured to fit within the interior of the cam compression spring 51 positioned against and atop the cam.

The spring retainer 52 includes a central flange or collar 62 configured to fit within the interior of the helical compression spring 63 opposite the cam 50. The spring retainer 52 includes a groove 66 configured to receive a roll pin 67 which is journalled through the roll pin mounting holes 18 so as to lock the position of the spring, retainer 52 and retain the spring 51 is a compressed state forcing the cam against the cam follower 49 in a downwardly direction with reference to the drawings. The spring retainer 52 also includes two oppositely disposed flanges or tongues 53 which are configured to be received within cartridge grooves 19 to prevent relative rotation between the spring retainer 52 and cartridge 12.

The hinge 10 also includes a nylon washer 69 and a horseshoe or omega shaped retaining ring 70 journalled onto the exposed portion of the bushing main portion 29 and in engagement with the mounting flange stop flange 25. A jamb or cabinet mounting bracket 72 is coupled so that an offset square shaped bracket mounting hole 73 therein receives the pivot pin square shaped end section 40, which prevents relative rotation between the pivot pin and the cabinet mounting bracket 72. A lock washer 75 is positioned against the cabinet mounting bracket 72 which is all secured in place through the threaded mounting of bracket mounting screw 46. The cabinet mounting bracket 72 includes a set of mounting holes 77 configured to receive threaded mounting screws 78 which are to be threaded into a conventional jamb or cabinet.

The hinge 10 is assembled by coupling the cam follower 49 onto the pivot pin by sliding the cam follower 49 along the pivot pin round shaft section until the pivot pin square shoulder section 43 is received within the cam follower square mounting hole 55, which enables the installer to insure that the cam follower is aligned in the correct position relative to the cartridge during the installation process and also allows for the releasing of the cam follower from the pivot pin if necessary for subsequent repair, replacement, or alignment. The bushing 28 is passed through the cartridge channel and into the pivot pin mounting hole 24 of the mounting flange (housing). The combination pivot pin and cam follower is then passed into the cartridge interior channel 16 with the mounting portion 34 of the pivot pin passing through the bushing round central passage 31. The cam 50 is then journalled onto the pivot pin shaft 44 with the cam oppositely disposed tongues 66 fitted within the cartridge grooves 19 to prevent rotation of the cam 50. The compression spring 51 is then fitted upon the cam collar 62 and the spring retainer collar 65 is fitted upon the opposite end of the compression spring 51 with the retainer tongues 53 fitted within cartridge grooves 19. The compression spring 51 is compressed through the mounting of retainer 52 which is locked in position through the positioning of roll pin 67 through roll pin mounting holes 18 and within retainer groove 66. As such, it should be understood that the cam follower is fitted onto the pivot pin without having to be overmolded, as the square shoulder prevents relative rotation therebetween.

In use, a separate bushing or pivot device is fitted into the door opposite hinge 10 so that a pivot bracket may be coupled to the bushing to form a stationary type hinge. The hinge 10 of the present invention is coupled to the door by passing the cartridge 12 into a square channel of the door with the mounting flange 20 abutting the bottom end of the door. The hinge 10 is fixed in place by passing mounting screws 22 through the mounting holes 21 within the mounting flange 20 and threading them into the bottom end of the door. The cabinet mounting bracket 72 is then coupled to the jamb or cabinet by passing mounting screws 78 through bracket mounting holes 77 and into the jamb, it being understood that the cabinet mounting bracket will need to be rotated, thereby compressing the spring during the mounting process.

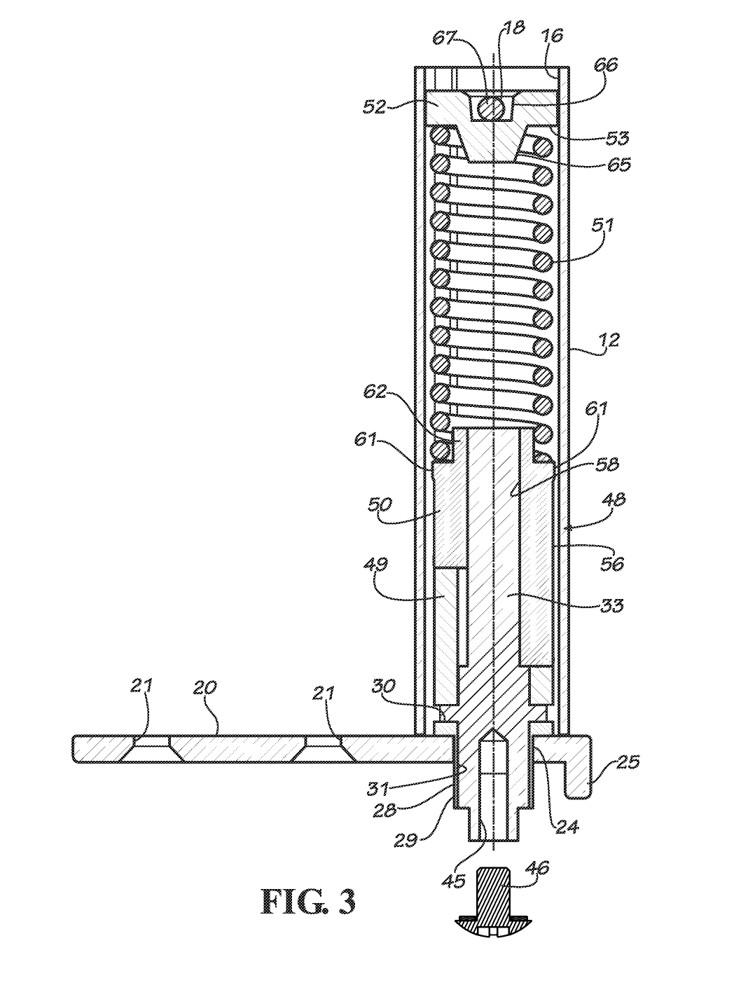

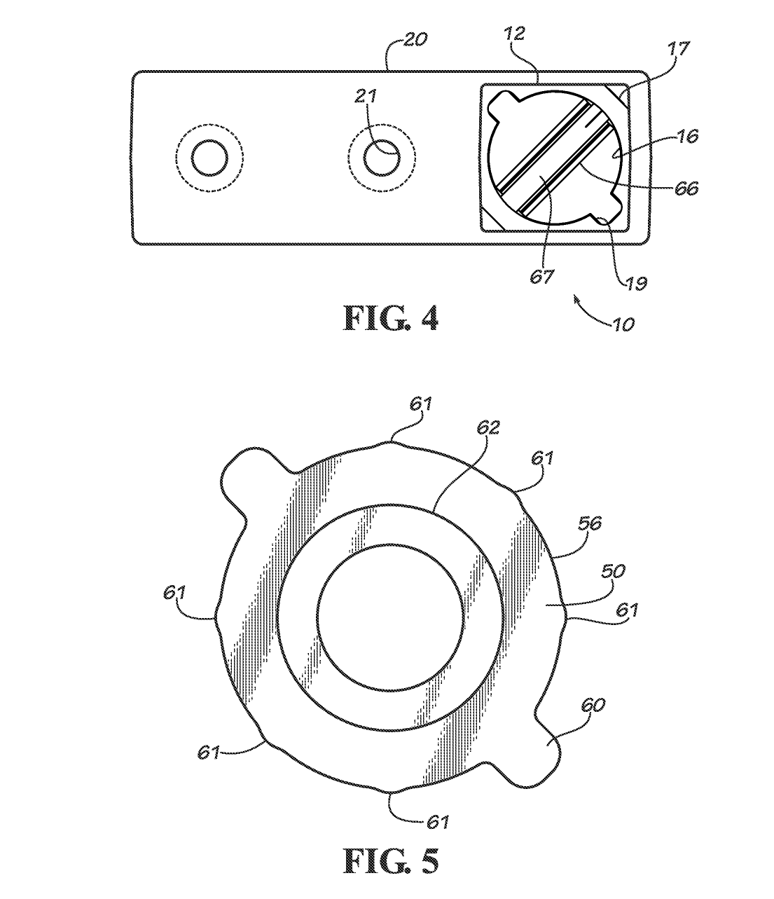

As shown in FIG. 3, with the door in a closed position the cam 50 Fits against the cam follower 49 with their corresponding camming surfaces 57 and 54 flush against each other in a lowermost position. As the door is rotated open through the hinge 10, the cam follower camming surface 54 rides along the cam camming surface 57 thereby lifting the door vertically, as shown in FIG. 4. This movement between the cam and cam follower causes further compression of the compression spring 51. If a flat portion or dwell of the camming surfaces exists and is reached, the door will remain in place at that position, otherwise the compression force of the compression spring 51 and the weight of the door will cause the hinge to return the door towards its initial, door closed position.

The existence of the cam guides 61 aid in preventing binding between the cam 50 and the interior channel 16 of the cartridge 12 during relative cam rotation and resulting vertical movement, a problem that has long existed with prior art hinges.

It should be understood that any non-round configuration of the square shoulder section 43 and corresponding cam follower square mounting hole 55 may be utilized so long as relative rotation therebetween is prevented, i.e., the square shape may be replaced by other non-circular geometric shapes. Also, as an alternative, a set pin may be passed through the pivot pin and cam follower to prevent rotation therebetween. The releasability between the cam follower and the pivot pin (unencumbered removal of the cam follower from the pivot pin) allows for the repair of the cam follower without having to replace the pivot pin. It should be understood that the current invention allows for the use of a steel pivot pin for strength, and especially greater shearing strength, while also allowing for the use of a better friction reducing material to be used for the cam follower. Thus, the present invention provides for greater strength while still providing great camming action and efficiency with the plastic cam follower to plastic cam interaction.

It should be understood that the terms cam and cam follower may be used interchangeably, as each simply includes a sloping surface configured to ride upon the other's sloping surface.

While this invention has been described in detail with particular reference to the preferred embodiments thereof and the best mode of practicing same, it will be understood that variations and modifications can be effected within the spirit and scope of the invention as described herein above and as set forth in the appended claims.

1. A method of assembling a hinge comprising the steps of:
(A) providing a tubular hinge housing having an interior channel terminating at an end wall with a pivot pin mounting hole therethrough, a mounting flange extending outwardly from the tubular hinge housing, a bushing configured to fit within the tubular hinge housing end wall pivot pin mounting hole, a casement tilting bracket, a metal pivot pin having at least a cam follower mounting portion with a non-round shoulder section and a round shaft section, a separate and distinct cam follower having a non-round hole therein configured to mate with the pivot pin cam follower mounting portion non-round shoulder section, a cam corresponding to the cam follower and having a channel therein configured to receive the pivot pin round shaft section, a compression spring, and a spring retainer;
(B) positioning the distinct and separate cam follower onto the metal pivot pin with the cam follower non-round hole receiving the pivot pin non-round shoulder section;
(C) inserting the bushing and the combination metal pivot pin and cam follower into the interior channel of the tubular hinge housing with a portion of the pivot pin extending from the tubular hinge housing end wall pivot pin mounting hole;
(D) positioning the cam onto the cam follower with the metal pivot pin extending through the cam channel;
(E) positioning the spring against the cam;
(F) positioning the spring retainer against the spring opposite the cam;
(G) coupling the spring retainer to the tubular hinge housing; and
(H) coupling the casement mounting bracket to the portion of the pivot pin extending from the tubular hinge housing end wall pivot pin mounting hole.

2. The method of claim 1, wherein the tubular hinge housing channel has a select diameter and wherein the cam has an annular array of outwardly extending guides defining a periphery corresponding to the tubular hinge housing channel select diameter.

3. The method of claim 2 wherein the annular array of outwardly extending guides is an annular array of generally vertically oriented elongated ridges.

4. The method of claim 1 wherein the pivot pin includes a stop flange positioned closely to the non-round shoulder section opposite the round shaft section, wherein the tubular hinge housing has an end with a pivot pin mounting hole therein, and wherein step (C) the combination metal pivot pin and cam follower is fitted into the interior channel of the tubular hinge housing with the stop flange abutting the bushing and the cam follower abutting the stop flange.

5. The method of claim 1 wherein the non-round shoulder section is a generally square shaped shoulder section, and wherein the cam follower non-round hole is a generally square shaped hole corresponding to the square shaped shoulder section.

6. The method of claim 1 wherein the pivot pin is a steel pivot pin and the cam follower is a plastic material.

7. A method of assembling a hinge comprising the steps of:
(A) providing a tubular hinge housing having an interior channel terminating at an end wall with a pivot pin mounting hole therethrough, a mounting flange extending outwardly from the tubular hinge housing, a bushing configured to fit within the tubular hinge housing end wall pivot pin mounting hole, a casement mounting bracket, a metal pivot pin having at least a cam follower mounting portion and a round shaft section, a separate and distinct cam follower having a hole therein configured to mate with the pivot pin cam follower mounting portion, a cam corresponding to the cam follower and having a channel therein configured to receive the pivot pin round shaft section, a compression spring, and a spring retainer;
(B) releasably coupling the distinct and separate cam follower to the metal pivot pin to prevent relative rotational movement therebetween with the pivot pin cam follower mounting portion positioned within the cam follower hole;
(C) inserting the bushing and the combination metal pivot pin and cam follower into the interior channel of the tubular hinge housing with the bushing positioned within the end wall pivot pin mounting hole and a portion of the pivot pin extending outwardly from the tubular hinge housing end wall pivot pin mounting hole;
(D) positioning the cam in engagement with the cam follower with the metal pivot pin extending through the cam channel;
(E) positioning the spring against the cam;
(F) engaging the spring retainer with the spring opposite the cam;
(G) mounting the spring retainer to maintain the spring in a compressed condition, and
(H) coupling the casement mounting bracket to the portion of the pivot pin extending from the tubular hinge housing end wall pivot pin mounting hole.

8. The method of claim 7 wherein the tubular hinge housing channel has a select diameter and wherein the cam has an annular array of outwardly extending guides defining a periphery corresponding to the tubular hinge housing channel select diameter.

9. The method of claim 8 wherein the annular array of outwardly extending guides is an annular array of generally vertically oriented elongated ridges.

10. The method of claim 7 wherein the pivot pin includes a stop flange positioned between and in abutment with bushing and the cam follower.

11. The method of claim 7 wherein the pivot pin has a non-round shoulder section and the cam follower has a non-round hole adapted to snugly receive the pivot pin non-round should section.

12. The method of claim 11 wherein said non-round shoulder section is a general square shaped shoulder section, and wherein the cam follower non-round hole is a generally square shaped hole corresponding to the square shaped shoulder section.

13. The method of claim 1 wherein the pivot pin is a steel pivot pin and the cam follower is a plastic material.

14. A hinge comprising:
a cartridge configured to fit within a channel within a door, the cartridge having a housing having an interior channel terminating a an end wall with a pivot pin mounting hole therethrough, and a mounting flange extending outwardly from said housing;
a bushing configured to fit within the cartridge housing end wall pivot pin mounting hole;
a steel pivot pin having a cam follower mounting portion with a non-round shoulder section and a round shaft section, a pivot pin mounting portion, and a bearing flange positioned between said cam follower mounting portion and said pivot pin mounting portion, said bearing flange being positioned to abut and ride upon said bushing;
a separate and distinct plastic cam follower having a non-round hole therein configured to mate with said pivot pin cam follower mounting portion non-round shoulder section, said cam follower having at least one camming surface;
a plastic cam having at least one camming surface corresponding to the cam follower at least one camming surface, said cam having a pivot pin channel therein configured to receive the pivot pin round shaft section;
a compression spring applying a compression force forcing said cam against said cam follower, and
a casement mounting bracket coupled to said pivot pin.

15. The hinge of claim 14 wherein said cam has an annular array of outwardly extending guides defining a periphery corresponding to the housing interior channel.

16. The hinge of claim 15 wherein said annular array of outwardly extending guides is an annular array of generally vertically oriented elongated ridges.

17. The hinge of claim 14 wherein said non-round shoulder section is a generally square shaped shoulder section, and wherein the cam follower non-round hole is a generally square shaped hole corresponding to said square shaped shoulder section.
